(19) United States
(12) Patent Application Publication
(10) Pub. No.: US 2025/0335181 A1
(43) Pub. Date: Oct. 30, 2025

(54) DATA PROCESSING SYSTEM MANAGEMENT USING DISTANCE MATRICES

(71) Applicant: Dell Products L.P., Round Rock, TX (US)

(72) Inventors: VINAY SAWAL, Fremont, CA (US); TSEHSIN JASON LIU, Wellesley, MA (US); CARL ASHBY, Derry, NH (US)

(21) Appl. No.: 18/646,148

(22) Filed: Apr. 25, 2024

(51) Int. Cl. G06F 8/71

(52) U.S. Cl. CPC G06F 8/71

(57) ABSTRACT

Methods and systems for managing data processing systems are provided. A similarity estimation process may be employed to identify and quantify similarit(ies) and/or difference(s) between two or more data processing systems in a normalized and quantitative manner. Such similarit(ies) and/or difference(s) may be used to determine whether adjustments to the data processing systems are necessary.

### FIELD

Embodiments disclosed herein relate generally to managing data processing systems. More particularly, embodiments disclosed herein relate to managing data processing systems using similarities and/or differences identified between the data processing systems.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a diagram illustrating a system in accordance with one or more embodiments.

FIGS. 2A-2C show data flow diagrams in accordance with one or more embodiments.

FIGS. 2D-2G show implementation examples in accordance with one or more embodiments.

FIGS. 3A-3B show flow diagrams illustrating methods in accordance with one or more embodiments.

FIG. 4 shows a block diagram illustrating a data processing system in accordance with one or more embodiments.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing data processing systems. In particular, data processing systems (e.g., servers, storage, or the like) may be provisioned (e.g., individually or in a group making up one or more deployments) to provide computer-implemented services (e.g., storage service, software services, or the like).

Overtime, these data processing systems may be subjected to various changes (e.g., configuration updates, crashes, resets, bug-fixes, hardware and/or software related repairs, or the like). Overtime, the computer-implemented services required by users (e.g., clients) may also change.

To ensure that these data processing systems are still working as intended, one or more embodiments may employ a similarity estimation process that identifies and quantifies the similarit(ies) and/or difference(s) between data processing systems (e.g., an ideal system set as a control, other existing data processing systems, etc.). Such identified similarities and/or differences may be used to determine whether adjustments to one or more data processing systems may be necessary.

For example, assume that two data processing systems are provisioned to perform the same task/function (e.g., as a server). Ideally, the performance, metrics, configurations (and other parameters/specifications) of these two data processing systems should remain identical throughout their lifetime. However, assume that one of the two data processing systems experienced a malfunction and needed to be taken offline temporarily for maintenance (e.g., a hard drive replacement or the like). Once back online, this data processing system may now have slightly deviated (e.g., in configurations, metrics, performance, etc.) from the other data processing system that did not break down. Being able to identify and quantify such similarit(ies) (and/or differences) between these two data processing systems would advantageously allow an entity managing these data processing systems to make adjustments (to one or both of the data processing systems) such that they again operate at substantially identical performance levels.

As another example, an entity managing data processing systems may receive a request to improve (e.g., in speed, efficiency, or the like) currently provided computer-implemented services. To do so, this entity may need to find two (or more) data processing systems with similar specifications that can work in tandem to provide the improved computer-implemented services. Being able to identify and quantify such similarit(ies) (and/or differences) between the data processing systems owned by this entity would advantageously allow this entity to quickly and efficiently identify the two (or more) data processing systems that are needed.

One of ordinary skill may appreciate that other use cases that can benefit from having identified and quantified such similarit(ies) (and/or differences) between data processing systems, groups of data processing system, or even just the components installed within these data processing systems may exist without departing from the scope of embodiments disclosed herein.

Furthermore, the functionalities of these data processing systems may also be improved. For example, identifying and quantifying such similarit(ies) (and/or differences) between data processing systems may also allow for identification of data processing systems that may be damaged (either physically or internally due to malware) as these damaged data processing systems may not be operating at a level of performance expected by an entity managing these data processing systems. Thus, the functionalities of these damaged data processing systems may be improved by quickly identifying and resolving the damages to restore the data processing system back to an ideal operation state.

In an embodiment, a method for managing data processing systems is provided. The method may include: obtaining system data, the system data comprising first system data of a first data processing system of the data processing systems and second system data of a second data processing system of the data processing systems; using the first system data and the second system data to calculate a similarity value for the first data processing system and the second data processing system; generating one or more system adjustment instructions using the similarity value; and causing, based on the one or more system adjustment instructions, adjustments to at least one of the first data processing system and the second data processing system.

Using the first system data and the second system data to calculate the similarity value may include: generating a first system distance matrix using the first system data and a second system distance matrix using the second system data, wherein the similarity value is a distance score between the first system distance matrix and the second system distance matrix.

The distance score is a Wasserstein distance between the first system distance matrix and the second system distance matrix.

The first system data comprises first components of the first data processing system and first attributes of each of the first components, and the second system data comprises second components of the second data processing system and second attributes of each of the second components.

The method may further include: generating a similarity matrix for the data processing systems, the data processing systems comprising the first data processing system, the second data processing system, and other ones of the data processing systems different from the first data processing system and the second data processing system, and the similarity matrix being a distance matrix; storing the similarity value for the first data processing system and the second data processing system into the similarity matrix; and providing the similarity matrix to an entity associated with management of the data processing systems.

The similarity value indicates that the second data processing system comprises similar components and configurations as the first data processing system. Causing the adjustments may include: grouping the first data processing system and the second data processing system into a deployment to jointly provide computer implemented services previously provided by only the first data processing system.

Causing the adjustments may include: executing the one or more system adjustment instructions to automatically, without user intervention, cause the at least one of the first data processing system and the second data processing system to process the adjustments.

Causing the at least one of the first data processing system and the second data processing system to process the adjustments may include causing the at least one of the first data processing system and the second data processing system to execute one or more configuration changes.

Causing the adjustments may include: providing the one or more system adjustment instructions to an entity associated with the data processing systems for the entity to manually adjust the at least one of the first data processing system and the second data processing system.

Manually adjusting the at least one of the first data processing system and the second data processing system may include modifying one or more hardware components of the least one of the first data processing system and the second data processing system.

In an embodiment, a non-transitory media is provided. The non-transitory media may include instructions that when executed by a processor cause the computer-implemented method to be performed.

In an embodiment, a data processing system is provided. The data processing system may include the non-transitory media and a processor, and may perform the computer-implemented method when the computer instructions are executed by the processor.

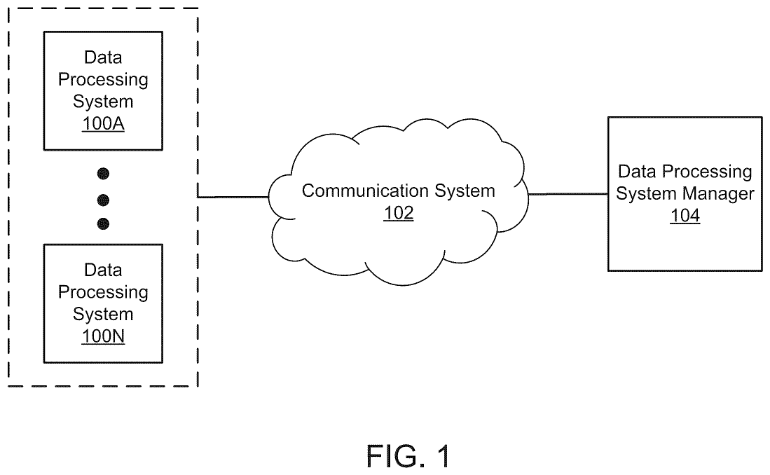

Turning to FIG. 1, a system in accordance with an embodiment is shown. The system may provide any number and types of computer implemented services (e.g., to user of the system and/or devices operably connected to the system). The computer implemented services may include, for example, data storage service, instant messaging services, etc.

To provide the computer implemented services, various data processing systems may be configured in predetermined manners to place them in operating states that are known to allow the computer implemented services to be provided. However, overtime, these data processing systems may be subjected to various changes (e.g., configuration updates, crashes, resets, bug-fixes, hardware and/or software related repairs, or the like). Overtime, the computer-implemented services required by users (e.g., clients) may also change.

For example, assume that two data processing system are provisioned. Both data processing systems are configured as remote storage devices. However, one data processing system receives a first set of updates while the other data processing system receives a second set of updates different from the first set of updates. These two data processing systems now operate at different operation levels.

A similarity estimation process may be employed to identify and quantify similarit(ies) (and/or difference(s)) between these two data processing systems in a normalized and quantitative manner. Such similarit(ies) (and/or difference(s)) may be used determine how much the two data processing systems have started to vary overtime. This information can then be used to determine whether adjustments are necessary to bring the operating levels of these two data processing systems back to a same level.

To provide the above noted functionality, the system may include data processing systems 100A-100N, and data processing system manager 104. Each of these components is discussed below.

Data processing systems 100A-100N may (individually or in any combination) provide desired computer implemented services. Data processing systems 100A-100N may (i) contribute to the computer implemented services, (ii) provide information regarding its configuration to data processing system manager 104, and (iii) update its configuration based on information provided by data processing system manager 104.

Data processing system manager 104 may provide management services for data processing systems 100A-100N. The management services may be performed by (i) monitoring changes (e.g., proposed changes) to data processing systems 100A-100N, (ii) identifying whether the proposed changes are acceptable and/or may be improved, and (iii) when the proposed changes are unacceptable and/or may be improved, data processing system manager 104 may provide information to an owner (e.g., user) of data processing systems 100A-100N.

In an embodiment, users of data processing systems 100A-100N may contract with operators of data processing system manager 104 for desired computer implemented services. For example, it may be the responsibility of an operator of data processing system manager 104 to maintain data processing systems 100A-100N in a manner that allows for the computer implemented services to be provided. A subscription model (e.g., one example of system policies) for such services may be utilized, which may define responsibilities, cost, and/or other aspects of the relationship between users of computer implemented services provided by data processing systems 100A-100N and operators of data processing system manager 104.

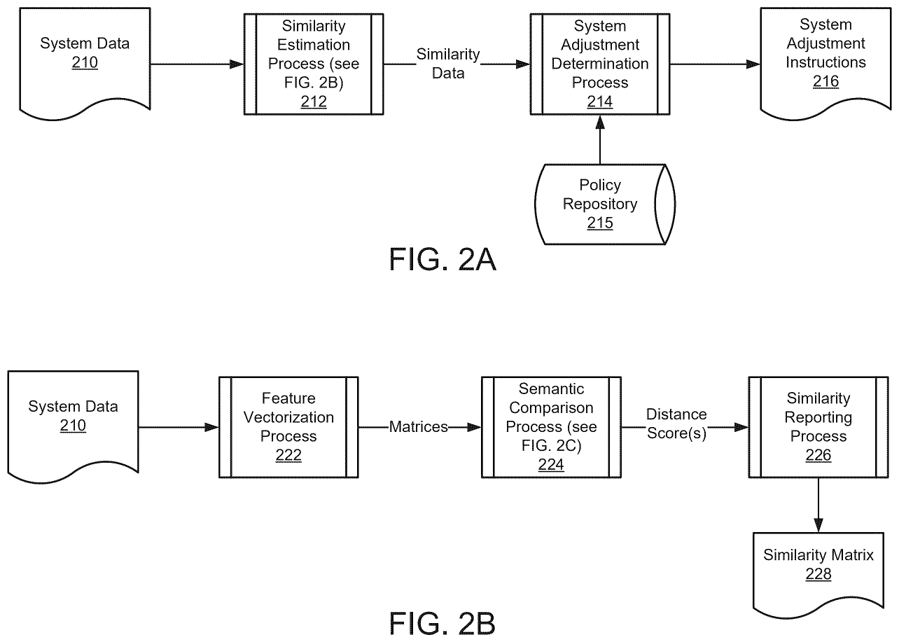

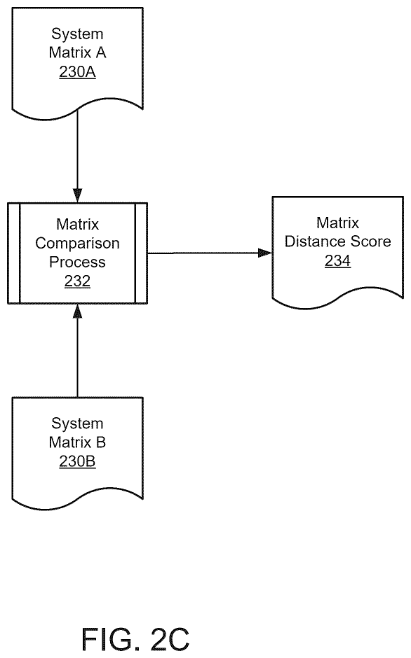

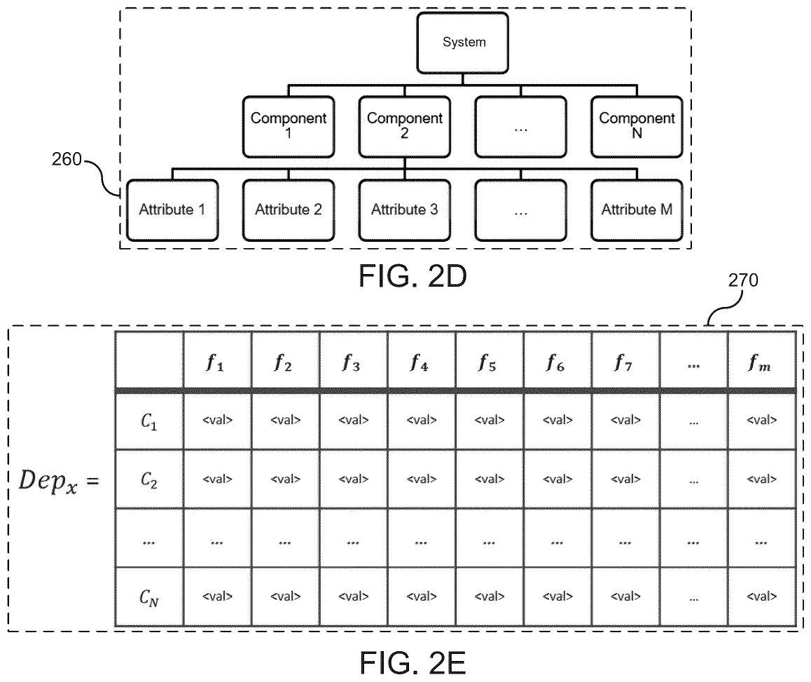

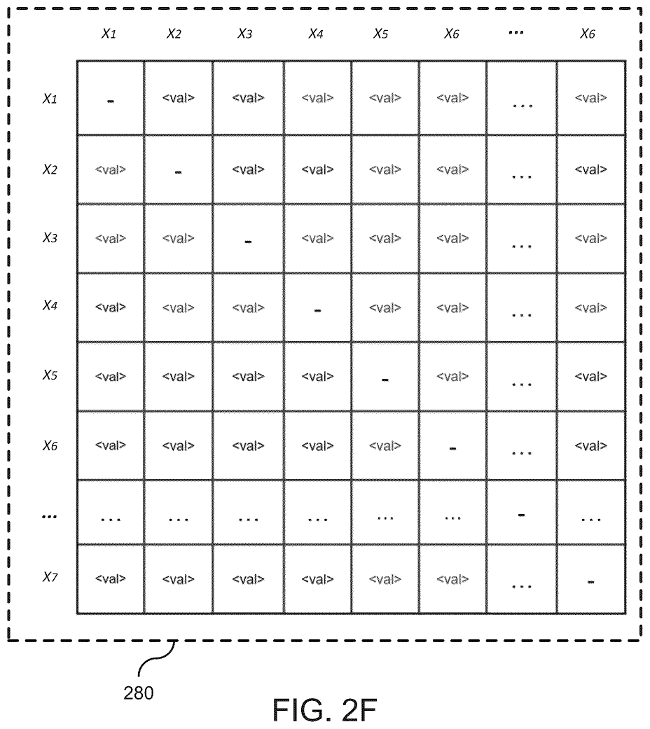

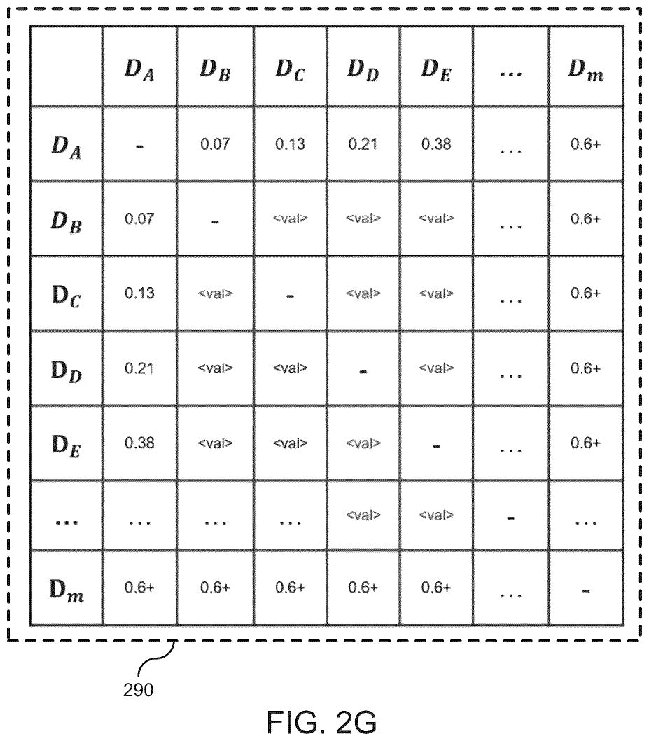

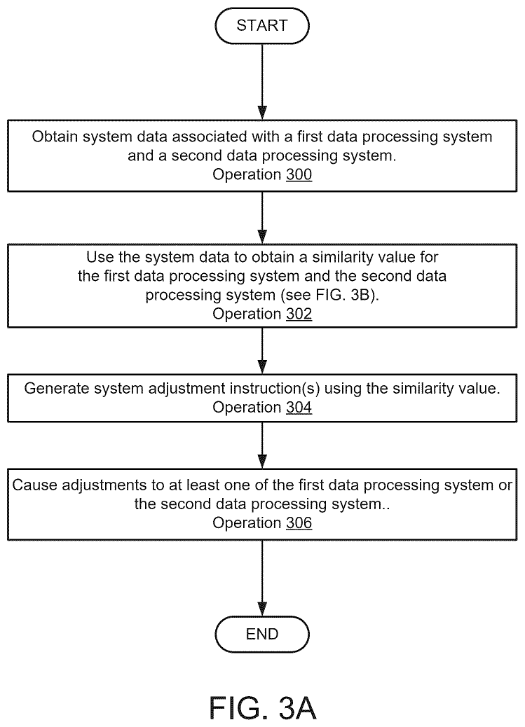

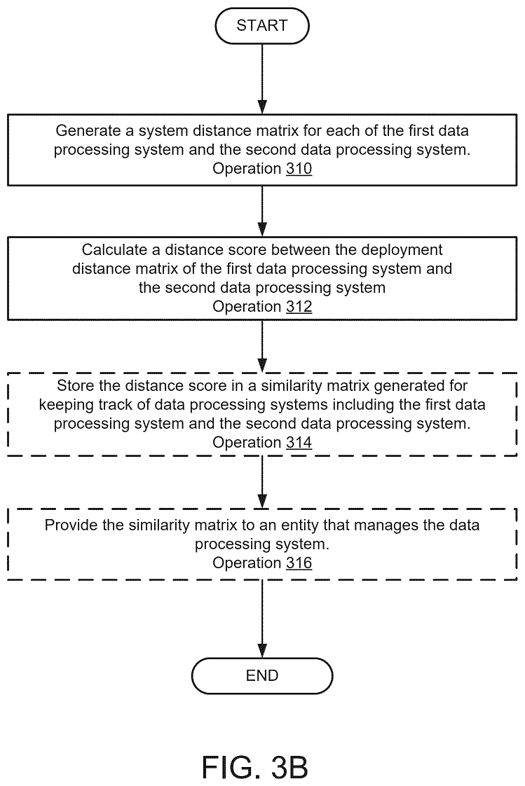

While providing their functionality, any of data processing systems 100A-100N and data processing system manager 104 may perform all, or a portion, of the flows and methods shown in FIGS. 2A-3B.

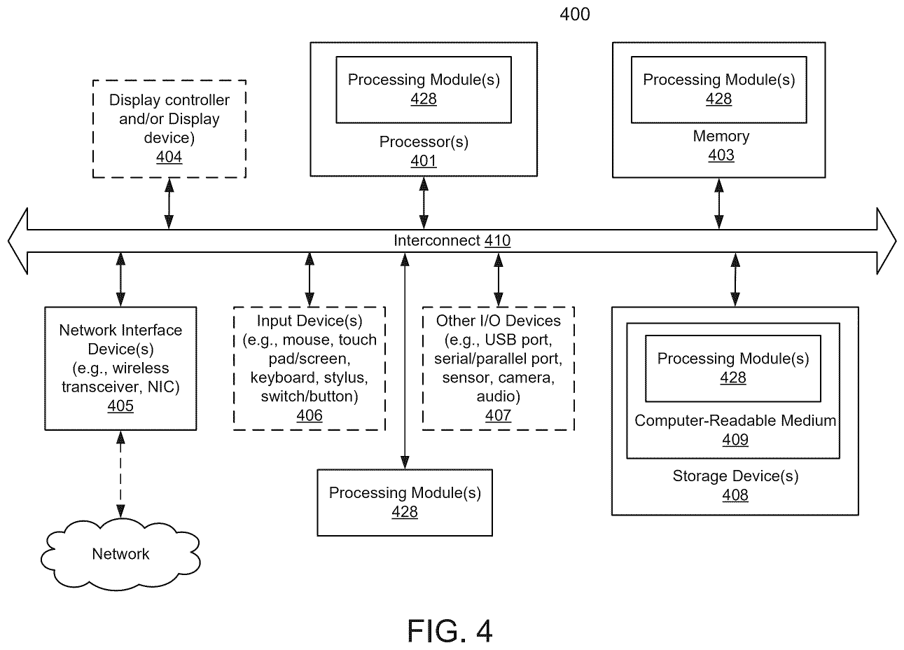

Any of (and/or components thereof) data processing systems 100A-100N and data processing system manager 104 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

Any of the components illustrated in FIG. 1 may be operably connected to each other (and/or components not illustrated) with communication system 102. In an embodiment, communication system 102 includes one or more networks that facilitate communication between any number of components. The networks may include wired networks and/or wireless networks (e.g., and/or the Internet). The networks may operate in accordance with any number and types of communication protocols (e.g., such as the Internet protocol).

While illustrated in FIG. 1 as including a limited number of specific components, a system in accordance with an embodiment may include fewer, additional, and/or different components than those components illustrated therein.

To further clarify embodiments disclosed herein, data flow diagrams in accordance with an embodiment are shown in FIGS. 2A-2C. In these diagrams, flows of data and processing of data are illustrated using different sets of shapes. A first set of shapes (e.g., 210, 216, 228 etc.) is used to represent data structures, a second set of shapes (e.g., 212, 214, 224, etc.) is used to represent processes performed using and/or that generate data, and a third set of shapes (e.g., 215, etc.) is used to represent large scale data structures such as databases.

Turning to FIG. 2A, a first data flow diagram in accordance with one or more embodiments is shown. The first data flow diagram may illustrate data used for the similarity estimation process of embodiments disclosed herein.

As shown in FIG. 2A, system data 210 may be obtained. A system data 210 may be obtained for each of the data processing system (e.g., 100A-110N) within the system. The system data 210 may include all information (e.g., specification, parameters, metrics, components (software and/or hardware), configurations, changes over time, or the like) regarding each data processing system.

Any and all information that can be obtained from each data processing system (e.g., from the logs, hardware, software, or the like of the data processing systems) may be included in the system data 210 without departing from the scope of embodiments disclosed herein. An example system data 210 of one data processing system is shown in FIG. 2D.

Turning to FIG. 2D, FIG. 2D shows an example hierarchy tree 260 included in a system data (e.g., 210 of FIG. 2A) of a data processing system (e.g., data processing system 100A of FIG. 1). Although sub-components are not shown, this hierarchy tree 260 may also include various sub-components, each with their own set of attributes. As shown in FIG. 2D, data processing system 100 may include various components (e.g., component 1 through N). Each of these components may then have a set of attributes (e.g., attributes 1 through M).

Each of the attributes may relay information about each component. Such information may include, but is not limited to: dependency information, business semantics information, behavioral statistics information. Business semantics may be attributes gathered by business metrics and may include, for example: total number of bug fixes, severity of bug fixes, total number of new updates, criticality of updates, security hot-fix, dependency components predecessor, dependency components successor, other data processing systems affected, reboot requirement, or the like. Behavioral statistics may include, for example: total number of configurations changed, total number of updates, ratio of changed configurations vs total configurations, number of programmers involved, time range of updates, total number of software libraries involved, number of hardware components replaced, total number of hardware components, number of bugs and/or anomalies detected (e.g., in the logs), or the like. Dependency information may indicate each upstream and or downstream dependency of a component.

Each component may be a hardware, software, or a combination of both of the data processing system. In particular, each component may be a feature or service (e.g., computer-implemented service) provided by the data processing system 100A.

Turning back now to FIG. 2B, system data 210 may be obtained for at least two data processing systems. The first data processing systems of the two data processing systems may be a control (e.g., an ideal system with idea configurations, metrics, or the like) that is pre-defined by the entity that manages the data processing systems (e.g., does not actually exist in reality). The second data processing systems of the two data processing systems may an already deployed (e.g., provisioned) data processing systems.

Alternatively, the system data 210 may be associated with two currently deployed data processing systems. Even further, the system data 210 may be associated with a currently deployed data processing system and a proposed modified version (e.g., configuration modification, hardware modification, or the like) of the currently deployed data processing system.

For simplicity and ease of explanation, the below examples of FIGS. 2B and 2C will be discussed with respect to only two data processing systems. However, any number of data processing systems (deployed, retired, proposed) may be compared using the similarity estimation process 212 of FIG. 2A without departing from the scope of embodiments disclosed herein.

The system data may be ingested into similarity estimation process 212. The similarity estimation process 212 may be configured to identify and quantify similarities (and/or differences) between these two deployments in a normalized and quantitative manner. Such similarities (and/or differences) may be used to determine whether adjustments are necessary to any of the data processing systems.

Turning first to FIG. 2B, FIG. 2B shows a second data flow diagram in accordance with one or more embodiments directed to the similarity estimation process 212 of FIG. 2A. Initially, the system data 210 (of the two data processing systems) is ingested into a feature vectorization process 222 where the system data 210 is transformed into matrices (e.g., distance matrices). Other types of matrices (besides distance matrices) may also be used without departing from the scope of embodiments disclosed herein.

To transform the system data 210 into distance matrices, the system data 210 is first converted into an n×m matrix 270 as shown in FIG. 2E. The n×m matrix 270 is an example matrix generated using the hierarchy tree 260 shown in FIG. 2D. In particular, as shown in FIG. 2E, each the set of attributes for every component is represented as an m-dimensional vector. Each attribute can be depicted as a feature (e.g., features fl through fm). Components of the deployment are then stacked to achieve the n×m matrix 270.

In embodiments, feature data may require transformation before further processing to result in the values (e.g., “<val>”) shown in the n×m matrix 270. For example, categorical (e.g., nominal, ordinal, or the like) criteria may be converted into numeric features using, for example, label encoders, one-hot vector encoders, or the like. Data for each criterion may also be normalized using techniques such as: unity base, linear, vector, or the like. Other techniques (and/or encoders) not listed here may also be used without departing from the scope of embodiments disclosed herein.

Once the n×m matrix 270 is obtained for each data processing system (e.g., two currently deployed data processing systems), the matrices are ingested into a semantic comparison process 224 as shown in FIG. 2B.

In particular, as part of the semantic comparison process 224, each matrix can be thought of as a distribution in an n-dimensional space (e.g., two empirical distributions of X={x₁, x₂, . . . xₙ} and Y={y₁, y₂, . . . yₘ} where xᵢ and yⱼ are discrete points representing attributes of two deployments. These two empirical distributions may be defined as:

$$μ = {\sum }_{i}^{n} {p}_{i} {δ}_{{x}_{i}} and v = {\sum }_{j}^{m} {q}_{j} {δ}_{{y}_{j}} \qquad ( Equation 1 )$$

where p and q are vectors of probability weights associated with each point-set. This representation provides “importance” to some attributes over others depending on the probability of occurrence in the joint probability distribution space, and will result in the construction of a distance matrix for each of the deployments. An example of a distance matrix 280 constructed for a deployment is shown in FIG. 2F.

As shown in FIG. 2F, the distance matrix 280 includes each attribute (namely, attributes X₁ through Xₙ) that was included in the n×m matrix 270 shown in FIG. 2E. The distance matrix 280 also shows the importance (e.g., as the values “<val>”) to some attributes over others depending on the probability of occurrence in the joint probability distribution space. For example, since X₁ is the same as X₁, there would be no value to show how the difference between this attribute. However, a value (“<val>”) is shown to show the difference (e.g., importance) between attributes X₁ and X₂.

Once distance matrices (e.g., distance matrix 280) have been generated for each of the two data processing systems, the semantic comparison process 224 employs a matrix comparison process 232 (as shown in FIG. 2C) to generate a matrix distance score 234. In particular, as shown in FIG. 2C, a system matrix A 230A (e.g., the distance matrix for the first data processing system) and a system matrix B 230B (e.g., the distance matrix for the second data processing system) are fed into the matrix comparison process 232 to obtain a matrix distance score 234.

The matrix comparison process 232 may be configured to calculate a Wasserstein distance (as the matrix distance score) between system matrix A 230A and system matrix B 230B. The Wasserstein distance may be calculated using the Wasserstein distance-based Optimal transport technique/calculation. In embodiments, a smaller Wasserstein distance indicates a greater similarity between the distributions, while a larger distance implies more dissimilarity. The cost associated with transporting unit mass for the two empirical distributions defined in terms of Wasserstein distance may be shown as:

$$ℒ ( {C}_{a} , {C}_{b} ) = Wd ( {C}_{a} , {C}_{b} ) = {\sum }_{ij}^{n} {Γ}_{ij} d ( {x}_{i} , {y}_{j} ) \qquad ( Equation 2 )$$

where Γᵢⱼ is the “mass” moved from x to y.

Once the matrix distance score 234 is obtained, the matrix distance score 234 may be provided to a similarity reporting process 226 shown in FIG. 2B. In particular, as part of the similarity reporting process 226, the matrix distance score 234 may be run through a normalization step where the distance metrics are normalized to real values between 0 and 1 instead of an arbitrary real value. This allows the comparison between the two data processing systems (e.g., the two currently deployed data processing systems) to be more easily understood.

In embodiments, during the similarity reporting process 226 of FIG. 2B, the matrix distance scores between various data processing systems may optionally be stored into another distance matrix 228. An example of this distance matrix 228 is shown in FIG. 2G.

As shown in FIG. 2G, a cumulative data processing system distance matrix 290 is shown where the matrix distance scores between various data processing systems are stored. In particular, the data processing systems (e.g., data processing systems D_{A} through Dₘ) are populated and compared against one another (using the matrix distance score (e.g., the values (“<val>”) shown in the cumulative data processing system distance matrix 290) calculated between each system).

Returning now to FIG. 2A, the similarity estimation process 212 may provide the matrix distance score 234 of the two data processing systems (as well as the distance matrix 228) as similarity data to system adjustment determination process 214.

The system adjustment determination process 214 may be configured to compare the similarity data to one or more policies (e.g., system policies, subscription information, corporate policies, business policies, or the like that are stored in policy repository 215) to determine whether any adjustments should be made to any of the two data processing systems. Such adjustments may include: (i) modifying any of the components (hardware and/or software) of any of the two data processing systems; (ii) causing any of the two data processing systems to execute one or more configuration changes; (iii) grouping the two data processing systems into a deployment to cooperatively provide computer-implemented services; (iv) retiring one or both of the two data processing systems; or the like.

Other adjustments required by the entity managing the data processing system (upon the entity understanding the similarities and/or differences between these two data processing systems) may be executed without departing from the scope of embodiments disclosed herein.

As a result, embodiments disclosed herein provide methods and systems that are advantageously allow entities to understand similarities and/or differences between various data processing systems such that these entities may quickly and effectively implement any necessary adjustments to these data processing systems to ensure that these data processing systems are operating as intended by the entity.

Additionally, although the above diagrams in FIGS. 2A-2G are described with respect to data processing systems, the above diagrams may be applicable to any level of similarity estimation including: (i) deployment level similarity estimation; (ii) system level similarity estimation; (iii) component/configuration level similarity estimation; or the like.

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the data structures illustrated using the first and third set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the components of FIG. 1 may perform various methods to manage data processing systems. FIGS. 3A-3B illustrate flow charts of methods that may be performed by the components of the system of FIG. 1 in accordance with an embodiment. In the diagrams discussed below and shown in FIGS. 3A-3B, any of the operations may be repeated, performed in different orders, and/or performed in parallel with or in a partially overlapping in time manner with other operations.

Turning to FIG. 3A, a first flow diagram illustrating a method for managing data processing systems in accordance with one or more embodiments is shown. The method may be performed, for example, by any of the components of the system of FIG. 1, and/or other components not shown therein.

At operation 300, as discussed above in reference to FIGS. 2A-2B, system data associated with a first data processing system and a second data processing system may be obtained.

At operation 302, as discussed above in reference to FIGS. 2A-2D, the deployment data (of the first and second deployments) may be used to determine risk(s) associated with deploying the second deployment.

The first data processing systems of the two data processing systems may be a control (e.g., an ideal system with idea configurations, metrics, or the like) that is pre-defined by the entity that manages the data processing systems (e.g., does not actually exist in reality). The second data processing systems of the two data processing systems may an already deployed (e.g., provisioned) data processing systems.

Alternatively, the system data may be associated with two currently deployed data processing systems. Even further, the system data may be associated with a currently deployed data processing system and a proposed modified version (e.g., configuration modification, hardware modification, or the like) of the currently deployed data processing system.

For simplicity and ease of explanation, the below examples of FIGS. 3A-3B will be discussed with respect to only two data processing systems. However, any number of data processing systems (deployed, retired, proposed) may be used in the processes discussed in FIGS. 3A-3B without departing from the scope of embodiments disclosed herein.

At operation 302, the system data (of the first and second data processing systems) is used to obtain (e.g., calculate) a similarity value for the first data processing system and the second data processing system. Additional details regarding the obtaining of the similarity value are discussed in the flow diagram of FIG. 3B, which include methods that may be performed, for example, by any of the components of the system of FIG. 1, and/or other components not shown therein.

In particular, at operation 310 of FIG. 3B, as discussed above in reference to FIGS. 2B and 2D-2F, a system distance matrix may be generated for each of the first data processing system and the second data processing system using the system data of each of the first data processing system and the second data processing system.

At operation 312, as discussed above in reference to FIGS. 2B-2C and 2G, a distance score (e.g., a matrix distance score 234 of FIG. 2C) may be calculated between the system distance matrices of the first data processing system and the second data processing system.

At operation 314, as discussed above in reference to FIGS. 2B and 2G, the distance score may (optionally) be stored in another distance matrix (e.g., cumulative data processing system distance matrix 290 of FIG. 2G) for keeping track of the similarities and/or differences between the various data processing systems of the system (e.g., data processing systems 100A-100N of FIG. 1).

At operation 316, if generated, the cumulative data processing system distance matrix may be provided to (e.g., displayed on a display for) an entity that manages the data processing systems.

The method of FIG. 3B may end following any of operations 312, 314, or 316.

Turning back to FIG. 3A, at operation 304, as discussed above in reference to FIGS. 2A-2B, system adjustment instructions may be generated based on the matrix distance score between the first data processing system and the second data processing system. The system adjustment instructions may be generated (automatically by the data processing system manager without user intervention or manually by one or more users of the data processing system manager) based on comparing the matrix distance score to one or more policies associated with the entity managing the data processing systems.

At operation 306, as discussed above in reference to FIGS. 2A-2B, the system adjustment instructions are executed (e.g., by the data processing system manager) to effectuate the system adjustment instructions on the first data processing system and/or the second data processing system.

Such adjustments may include: (i) modifying any of the components (hardware and/or software) of any of the two data processing systems; (ii) causing any of the two data processing systems to execute one or more configuration changes; (iii) grouping the two data processing systems into a deployment to cooperatively provide computer-implemented services (e.g., new computer-implemented services; computer-implemented services previously provided by only the first or the second data processing system; or the like); (iv) retiring one or both of the two data processing systems; or the like.

Other adjustments required by the entity managing the data processing system (upon the entity understanding the similarities and/or differences between these two data processing systems) may be executed without departing from the scope of embodiments disclosed herein.

The method of FIG. 3A may end following operation 306.

Although the above diagrams in FIGS. 3A-3B are described with respect to data processing systems, the above diagrams may be applicable to any level of similarity estimation including: (i) deployment level similarity estimation; (ii) system level similarity estimation; (iii) component/configuration level similarity estimation; or the like.

Any of the components illustrated in FIGS. 1-3B may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing data processing systems, the method comprising:
obtaining system data, the system data comprising first system data of a first data processing system of the data processing systems and second system data of a second data processing system of the data processing systems;
using the first system data and the second system data to calculate a similarity value for the first data processing system and the second data processing system;
generating one or more system adjustment instructions using the similarity value; and
causing, based on the one or more system adjustment instructions, adjustments to at least one of the first data processing system and the second data processing system.

2. The method of claim 1, wherein using the first system data and the second system data to calculate the similarity value comprises:
generating a first system distance matrix using the first system data and a second system distance matrix using the second system data,
wherein the similarity value is a distance score between the first system distance matrix and the second system distance matrix.

3. The method of claim 2, wherein the distance score is a Wasserstein distance between the first system distance matrix and the second system distance matrix.

4. The method of claim 3, wherein the first system data comprises first components of the first data processing system and first attributes of each of the first components, and the second system data comprises second components of the second data processing system and second attributes of each of the second components.

5. The method of claim 4, further comprising:
generating a similarity matrix for the data processing systems, the data processing systems comprising the first data processing system, the second data processing system, and other ones of the data processing systems different from the first data processing system and the second data processing system, and the similarity matrix being a distance matrix;
storing the similarity value for the first data processing system and the second data processing system into the similarity matrix; and
providing the similarity matrix to an entity associated with management of the data processing systems.

6. The method of claim 2,
wherein the similarity value indicates that the second data processing system comprises similar components and configurations as the first data processing system, and
wherein causing the adjustments comprises:
grouping the first data processing system and the second data processing system into a deployment to jointly provide computer implemented services previously provided by only the first data processing system.

7. The method of claim 2, wherein causing the adjustments comprises:
executing the one or more system adjustment instructions to automatically, without user intervention, cause the at least one of the first data processing system and the second data processing system to process the adjustments.

8. The method of claim 7, wherein causing the at least one of the first data processing system and the second data processing system to process the adjustments comprises causing the at least one of the first data processing system and the second data processing system to execute one or more configuration changes.

9. The method of claim 2, wherein causing the adjustments comprises:
providing the one or more system adjustment instructions to an entity associated with the data processing systems for the entity to manually adjust the at least one of the first data processing system and the second data processing system.

10. The method of claim 9, wherein manually adjusting the at least one of the first data processing system and the second data processing system comprises modifying one or more hardware components of the least one of the first data processing system and the second data processing system.

11. A non-transitory machine-readable medium having instructions stored therein, which when executed by a processor, cause the processor to perform operations for managing data processing systems, the operations comprising:
obtaining system data, the system data comprising first system data of a first data processing system of the data processing systems and second system data of a second data processing system of the data processing systems;
using the first system data and the second system data to calculate a similarity value for the first data processing system and the second data processing system;
generating one or more system adjustment instructions using the similarity value; and
causing, based on the one or more system adjustment instructions, adjustments to at least one of the first data processing system and the second data processing system.

12. The non-transitory machine-readable medium of claim 11, wherein using the first system data and the second system data to calculate the similarity value comprises:
generating a first system distance matrix using the first system data and a second system distance matrix using the second system data,
wherein the similarity value is a distance score between the first system distance matrix and the second system distance matrix.

13. The non-transitory machine-readable medium of claim 12, wherein the distance score is a Wasserstein distance between the first system distance matrix and the second system distance matrix.

14. The non-transitory machine-readable medium of claim 13, wherein the first system data comprises first components of the first data processing system and first attributes of each of the first components, and the second system data comprises second components of the second data processing system and second attributes of each of the second components.

15. The non-transitory machine-readable medium of claim 14, wherein the operations further comprise:
generating a similarity matrix for the data processing systems, the data processing systems comprising the first data processing system, the second data processing system, and other ones of the data processing systems different from the first data processing system and the second data processing system, and the similarity matrix being a distance matrix;
storing the similarity value for the first data processing system and the second data processing system into the similarity matrix; and
providing the similarity matrix to an entity associated with management of the data processing systems.

16. A data processing system manager, comprising:
a processor; and
a memory coupled to the processor to store instructions, which when executed by the processor, cause the deployment manager to perform operations for managing data processing systems, the operations comprising:
obtaining system data, the system data comprising first system data of a first data processing system of the data processing systems and second system data of a second data processing system of the data processing systems;
using the first system data and the second system data to calculate a similarity value for the first data processing system and the second data processing system;
generating one or more system adjustment instructions using the similarity value; and
causing, based on the one or more system adjustment instructions, adjustments to at least one of the first data processing system and the second data processing system.

17. The data processing system manager of claim 16, wherein using the first system data and the second system data to calculate the similarity value comprises:
generating a first system distance matrix using the first system data and a second system distance matrix using the second system data,
wherein the similarity value is a distance score between the first system distance matrix and the second system distance matrix.

18. The data processing system manager of claim 17, wherein the distance score is a Wasserstein distance between the first system distance matrix and the second system distance matrix.

19. The data processing system manager of claim 18, wherein the first system data comprises first components of the first data processing system and first attributes of each of the first components, and the second system data comprises second components of the second data processing system and second attributes of each of the second components.

20. The data processing system manager of claim 19, wherein the operations further comprise:
generating a similarity matrix for the data processing systems, the data processing systems comprising the first data processing system, the second data processing system, and other ones of the data processing systems different from the first data processing system and the second data processing system, and the similarity matrix being a distance matrix;
storing the similarity value for the first data processing system and the second data processing system into the similarity matrix; and
providing the similarity matrix to an entity associated with management of the data processing systems.
